(19) United States
(12) Patent Application Publication
(10) Pub. No.: US 2020/0272933 A1
(43) Pub. Date: Aug. 27, 2020

(54) METHOD AND APPARATUS FOR MINING TARGET FEATURE DATA

(71) Applicant: Alibaba Group Holding Limited, Grand Cayman, KY (US)

(72) Inventor: Jun ZHOU, Hangzhou (CN)

(21) Appl. No.: 16/063,755

(22) PCT Filed: Jan. 24, 2017
(86) PCT No.: PCT/CN2017/072404

§ 371 Date: Jun. 19, 2018

(30) Foreign Application Priority Data
Feb. 5, 2016 (CN) 201610082536.1

(51) Int. Cl. G06N 20/00; G06F 16/182

(52) U.S. Cl. CPC G06N 20/00; G06F 16/182

(57) ABSTRACT

Embodiments of the disclosure provide a method and an apparatus of mining target feature data. The method comprises: calculating a feature frequency of first feature data; obtaining second feature data by filtering out low frequency feature data from the first feature data based on the feature frequency; and obtaining the target feature data by filtering out at least part of mid-frequency feature data from the second feature data based on the feature frequency. The solutions provided in the embodiments of the disclosure do not affect the performance of a model essentially, and greatly reduce the number of features while ensuring the effect of machine learning. The embodiments therefore greatly reduce the needed number of machines and resources, which in turn greatly shortens the training time and increases the training speed, thereby lowering the training costs to the greatest extent.

### CROSS-REFERENCE TO RELATED APPLICATIONS

The disclosure claims priority of Chinese patent application No. 201610082536.1, filed on Feb. 5, 2016 and entitled “Method and Apparatus for Mining Target Feature Data” and Int'l Application No. PCT/CN17/072404 filed on Jan. 24, 2017 and entitled “MINING METHOD AND DEVICE FOR TARGET CHARACTERISTIC DATA” both of which are incorporated herein by reference in its entirety.

### BACKGROUND

### Technical Field

The disclosure relates to the technical field of computer processing, and in particular, to a method of mining target feature data and an apparatus of mining target feature data.

### Description of the Related Art

Machine Learning (ML) is a multi-disciplinary field involving many disciplines such as probability theory, statistics, approximation theory, convex analysis, algorithm complexity theory, and the like. It is mainly used in artificial intelligence to acquire new knowledge or skills, so as to reorganize existing knowledge structures to continually improve their performance.

Data and features are two important aspects in machine learning, which have a great impact on the effect of machine learning.

Using estimating the click-through rate (CTR) of a certain piece of information as an example, CTR estimation needs at least two aspects of data. A first aspect is the data of the information itself, and the other is the data of users. Assuming that all data has been collected, then the data can be used to estimate the likelihood (i.e., probability) of the users clicking on this piece of information.

Information has various features, including sizes, texts, industry-specific information, pictures, and the like. User data also has many features, including ages, genders, regions, occupations, schools, mobile phone platforms, and the like. Additionally, feedback feature is also seen, such as the real-time CTR of each piece of information.

However, increasing CTR is a long-term process. Users are changing and the creativity of information is also changing. Therefore, new features continue to be added.

Moreover, when a large number of ID-class features intersect with other features, i.e., ID-class features are multiplied by other features, the result is that the features of a 10-billion or even 100-billion data volume may be reached.

Assuming that there are 100,000 ID-class features and 100,000 pieces of information, the ID-class features intersect with the pieces of information, i.e., ID-class features directly multiplied by the information, resulting in a 10 billion feature scale.

The training of massive features with the use of machine learning often requires tens of thousands of machines, which occupy a lot of resources that continue unremittingly for one day or even longer. The training speed is slow with large resources consumed, resulting in extremely high training costs.

Currently, in order to reduce the number of features, one frequency threshold is generally preset and all features with their frequency lower than the frequency threshold are filtered out.

The method of globally filtering out features may possibly filter out a large number of useful features, which in turn reduces the effect of machine learning significantly.

### SUMMARY

In view of the problems mentioned above, embodiments of the disclosure are introduced to provide a method of mining target feature data and a corresponding apparatus of mining target feature data so as to overcome or at least in part solve the problems discussed previously.

In order to solve the problems mentioned above, an embodiment of the disclosure discloses a method of mining target feature data, comprising: calculating a feature frequency of first feature data; obtaining second feature data by filtering out low frequency feature data from the first feature data based on the feature frequency; and obtaining the target feature data by filtering out at least part of mid-frequency feature data from the second feature data based on the feature frequency.

Preferably, the method further comprises: training a specified model by employing the target feature data.

Preferably, the step of calculating a feature frequency of first feature data comprises: allocating the first feature data to one or a plurality of first working nodes; calculating, by the first working node, the feature frequency of the allocated first feature data; transmitting, by the first working node, to a second working node the calculated first feature data and the feature frequency; and combining, by the second working node, the calculated first feature data and the feature frequency.

Preferably, the step of obtaining second feature data by filtering out low frequency feature data from the first feature data based on the feature frequency comprises: determining that the first feature data is low frequency feature data when the feature frequency of the first feature data is lower than a preset low frequency threshold; and obtaining the second feature data by filtering out the first feature data.

Preferably, the step of obtaining second feature data by filtering out low frequency feature data from the first feature data based on the feature frequency comprises: allocating the first feature data and the feature frequency to the one or the plurality of first working nodes; obtaining the second feature data, by the first working node, by filtering out the low frequency feature data from the allocated first feature data based on the allocated feature frequency; transmitting, by the first working node, to the second working node the second feature data obtained through filtering and the feature frequency; and combining, by the second working node, the second feature data obtained through filtering and the feature frequency.

Preferably, the step of obtaining the target feature data by filtering out at least part of mid-frequency feature data from the second feature data based on the feature frequency comprises: configuring a random number for the second feature data; determining that the second feature data is the mid-frequency feature data when the product of the feature frequency of the second feature data and the random number is smaller than a preset mid-frequency threshold; and obtaining the target feature data by filtering out the second feature data.

Preferably, the step of obtaining the target feature data by filtering out at least part of mid-frequency feature data from the second feature data based on the feature frequency comprises: allocating the second feature data and the feature frequency to the one or the plurality of first working nodes; obtaining the target feature data, by the second working node, by filtering out at least part of the mid-frequency feature data from the allocated second feature data based on the allocated feature frequency; transmitting, by the first working node, to the second working node the target feature data obtained through filtering and the feature frequency; and combining, by the second working node, the target feature data obtained through filtering and the feature frequency.

Preferably, the method further comprises: training a first test model by employing first original feature data; training a second test model by employing the first original feature data having a feature frequency smaller than a first candidate threshold filtered out; performing an A/B testing on the first test model and the second test model to obtain a first score and a second score; and determining that the first candidate threshold is the low frequency threshold when a difference between the first click-through rate and the second click-through rate is smaller than a preset first threshold difference.

Preferably, the method further comprises: training a third test model by employing second original feature data; training a fourth test model by employing the second original feature data having filtered out the product of the feature frequency and the random number that is smaller than a second candidate threshold; computing a first feature probability and a second feature probability; and determining that the second candidate threshold is the low frequency threshold when a difference between the first feature probability and the second feature probability is smaller than a preset second threshold difference, wherein the first feature probability is a probability obtained when a score of a positive sample in the third test model is greater than a score of a negative sample in the third test model; and the second feature probability is a probability obtained when a score of the positive sample in the fourth test model is greater than a score of the negative sample in the fourth test model.

An embodiment of the disclosure further discloses an apparatus of mining target feature data, comprising: a feature frequency calculation module, configured for calculating a feature frequency of first feature data; a low frequency feature filtering module, configured for obtaining second feature data by filtering out low frequency feature data from the first feature data based on the feature frequency; and a mid-frequency feature filtering module, configured for obtaining the target feature data by filtering out at least part of mid-frequency feature data from the second feature data based on the feature frequency.

Preferably, the apparatus further comprises: a model training module, configured for training a specified model by employing the target feature data.

Preferably, the feature frequency calculation module comprises: a first allocation sub-module, configured for allocating the first feature data to one or a plurality of first working nodes; a frequency calculation sub-module, configured to be used by the first working node to calculate the feature frequency of the allocated first feature data; a first transmission sub-module, configured to be used by the first working node to transmit to a second working node the calculated first feature data and the feature frequency; and a first combination sub-module, configured to be used by the second working node to combine the calculated first feature data and the feature frequency.

Preferably, the low frequency feature filtering module comprises: a low frequency feature determination sub-module, configured for determining that the first feature data is low frequency feature data when the feature frequency of the first feature data is lower than a preset low frequency threshold; and a second feature data obtaining sub-module, configured for obtaining the second feature data by filtering out the first feature data.

Preferably, the low frequency feature filtering module comprises: a second allocation sub-module, configured for allocating the first feature data and the feature frequency to the one or the plurality of first working nodes; a first filtering sub-module, configured to be used by the first working node to obtain the second feature data by filtering out the low frequency feature data from the allocated first feature data based on the allocated feature frequency; a second transmission sub-module, configured to be used by the first working node to transmit to the second working node the second feature data obtained through filtering and the feature frequency; and a second combination sub-module, configured to be used by the second working node to combine the second feature data obtained through filtering and the feature frequency.

Preferably, the mid-frequency feature filtering module comprises: a random number configuration sub-module, for configuring a random number for the second feature data; a mid-frequency feature determination sub-module, configured for determining that the second feature data is the mid-frequency feature data when the product of the feature frequency of the second feature data and the random number is smaller than a preset mid-frequency threshold; and a target feature data obtaining sub-module, configured for obtaining the target feature data by filtering out the second feature data.

Preferably, the mid-frequency feature filtering module comprises: a third allocation sub-module, configured for allocating the second feature data and the feature frequency to the one or the plurality of first working nodes; a second filtering sub-module, configured to be used by the second working node to obtain the target feature data by filtering out at least part of the mid-frequency feature data from the allocated second feature data based on the allocated feature frequency; a third transmission sub-module, configured to be used by the first working node to transmit to the second working node the target feature data obtained through filtering and the feature frequency; and a third combination sub-module, configured to be used by the second working node to combine the target feature data obtained through filtering and the feature frequency.

Preferably, the apparatus further comprises: a first test model training module, configured for training a first test model by employing first original feature data; a second test model training module, configured for training a second test model by employing the first original feature data having a feature frequency smaller than a first candidate threshold filtered out; a test module, configured for performing an A/B testing on the first test model and the second test model to obtain a first score and a second score; and a low frequency threshold determination module, configured for determining that the first candidate threshold is the low frequency threshold when a difference between the first click-through rate and the second click-through rate is smaller than a preset first threshold difference.

Preferably, the apparatus further comprises: a third test model training module, configured for training a third test model by employing second original feature data; a fourth test model training module, configured for training a fourth test model by employing the second original feature data having filtered out the product of the feature frequency and the random number that is smaller than a second candidate threshold; a probability computation sub-module, configured for computing a first feature probability and a second feature probability; and a mid-frequency threshold determination module, configured for determining that the second candidate threshold is the low frequency threshold when a difference between the first feature probability and the second feature probability is smaller than a preset second threshold difference, wherein the first feature probability is a probability that a score of a positive sample in the third test model is greater than a score of a negative sample in the third test model; and the second feature probability is a probability obtained when a score of the positive sample in the fourth test model is greater than a score of the negative sample in the fourth test model.

The embodiments of the disclosure have the following advantages: through filtering out low frequency feature data and at least part of mid-frequency feature data in the embodiments of the disclosure, the obtained target feature data has high frequency feature data and may possibly have part of mid-frequency feature data. Training a model based on such target feature data does not affect the performance of a model essentially, and greatly reduces the number of features while ensuring the effect of machine learning. The solutions provided in the embodiments of the disclosure therefore greatly reduce the needed number of machines and resources, which in turn greatly shortens the training time and increases the training speed, thereby lowering the training costs to the greatest extent.

### BRIEF DESCRIPTION OF THE DRAWINGS

FIG. 1 is a flow diagram illustrating a method for mining target feature data according to some embodiments of the disclosure.

FIG. 2 is a block diagram illustrating an apparatus for mining target feature data according some embodiments of the disclosure.

### DETAILED DESCRIPTION

To make the above-mentioned objectives, features, and advantages of the disclosure more obvious and easy to understand, the disclosure is further described below in detail in combination with the accompanying figures and the specific implementations.

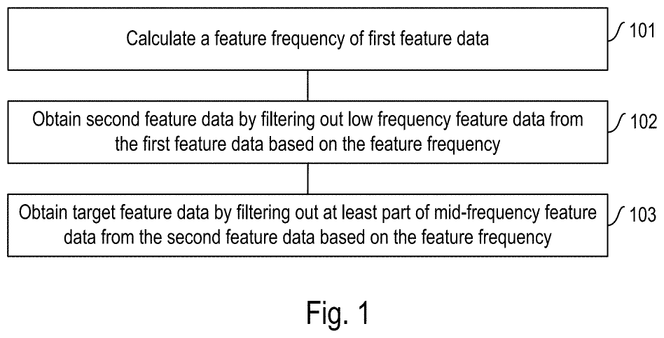

FIG. 1 is a flow diagram illustrating a method for mining target feature data according to some embodiments of the disclosure. The method may comprise the following steps.

Step 101: calculate a feature frequency of first feature data.

In one embodiment, source data can be collected through web logs. For example, source data may be parsed and meaningless information such as a field “-” may be removed, to obtain structured first feature data, like a user ID, a product ID accessed by a user, an access time, a user behavior (such as clicks, purchases, reviews), etc.

For example, a web logs may be structured as follows: 118.112.27.164- - -[24/Oct/2012:11:00:00+0800] “GET /b.jpg?cD17Mn0mdT17L2NoaW5hLmFsaWJhYmEuY29tL30mbT17R0VUfSZzPXsy MDB9JnI9e2h0dHA6Ly9mdy50bWFsbC5jb20vP3NwbT0zLjE2OTQwNi4xOTg0MD EufSZhPXtzaWQ9MTdjMDM2MjEtZTk2MC00NDg0LWIwNTYtZDJkMDcwM2Nk YmE4fHN0aW11PTEzNTEwNDc3MDU3OTZ8c2RhdGU9MjR8YWxpX2FwYWNoZ V9pZD0xMTguMTEyLjI3LjE2NC43MjU3MzI0NzU5ODMzMS43fGNuYT0tfSZiPXs tfSZjPXtjX3NpZ251ZD0wfQ==&pageid=7f0000017f000001135118030546741560716 47816&sys=ie6.0|windowsXP|1366*768|zh-cn&ver=43&t=1351047705828 HTTP/1.0” 200-“Mozilla/4.0 (compatible; MSIE 6.0; Windows NT 5.1; SV1;.NET CLR 2.0.50727)” 118.112.27.164.135104760038.6 1̂sid%3D17c03621-e960-4484-b056-d2d0703cdba8%7Cstime%3D1351047705796% 7Csdate%3D24|cna=-̂-̂aid=118.112.27.164.72573247598331.7

After filtering, the obtained structured first feature data is:

1,b2b-1633112210,1215596848,1,07/Aug/2013:08:27:22

In one embodiment, the first feature data may be filtered to obtain target feature data used for training a specified model.

If the amount of the first feature data is small, then the filtering may be performed using a single computer. If the amount of the first feature data is large, then the filtering may be performed in multiple computers, such as in a distributed system, Hadoop cluster, an Open Data Processing Service (ODPS), or similar system.

The distributed system may refer to a computer system composed of a plurality of interconnected processing resources that perform the same task collaboratively under the control of the entire system. These resources may be geographically adjacent or geographically dispersed.

To enable those skilled in the art to better understand the disclosed embodiments, Hadoop is used as the distributed system in one embodiment.

At a high level, Hadoop includes two parts: a distributed file system (Hadoop Distributed File System (HDFS)) and a distributed computing framework, MapReduce.

HDFS is a high fault-tolerant system that can provide high-throughput data access and is applicable to application programs with large data sets.

MapReduce is a set of programming models that extract analytical elements from massive source data and return result sets. The basic principle of MapReduce is that large data is divided into small blocks to be analyzed one by one and the extracted data is finally integrated for analysis.

In Hadoop, there are two machine roles for performing MapReduce: JobTracker and TaskTracker.

Among them, JobTracker can be used to schedule tasks, and TaskTracker can be used to perform tasks.

More specifically, in Hadoop, TaskTracker may refer to a processing node of the distributed system. The processing node may include one or more Map nodes and one or more Reduce nodes.

In distributed computation, MapReduce is responsible for dealing with complex issues in parallel programming such as distributed storage, work scheduling, load balancing, fault-tolerant equalization, fault-tolerant processing, network communication, and the like. MapReduce highly abstracts the processing process into two functions: a map function and a reduce function. The map function can decompose a task into multiple tasks and the reduce function can integrate the processing results of the decomposed multiple tasks.

In Hadoop, each task of MapReduce can be initialized into one Job. Each Job can be divided into two phases: a map phase and a reduce phase. The two phases are respectively represented by two functions: the map function and the reduce function.

The map function may receive an input in the form of <key, value> and then also produce an intermediate output in the form of <key, value>. The Hadoop function may receive an input in the form of, for example, <key, (list of values)> and then process the value set. Each reduce function produces 0 or 1 outputs. The output of the reduce function is also in the form of <key, value>.

In one embodiment, the pre-collected first feature data may be extracted to calculate the feature frequency (i.e., the amount of the first feature data) and filtering is further performed based on the feature frequency.

In one embodiment, step 101 may comprise the following sub-steps.

Sub-step S11: allocate the first feature data to one or a plurality of first working nodes.

In the distributed system, the first working node and a second working node are provided to perform filtering.

For example, in a distributed system such as Hadoop and ODPS, the first working node is a Map node and the second working node is a Reduce node.

In order to ensure the integrity of the calculation, when the first feature data is being allocated, it is generally ensured that the first feature data allocated to each first working node (such as a Map node) does not overlap, i.e., differs from one another.

In one embodiment, the first feature data may be represented in the form of a data ID.

Assuming that there are three pieces of first feature data, userid1, userid2, and userid3. The first feature data allocated to a first working node A is userid1; and the first feature data allocated to a first working node B is userid2 and userid3 but not userid1.

In practical applications, a hash complementation allocation method (hash(x) % N) is taken as an example. Each first working node (such as a Map node) is configured with a sequence number. One hash value is computed for each piece of first feature data. Then the hash value is divided by a specified value to obtain the remainder. The first feature data is allocated to the first working node (such as a Map node) whose sequence number value is the same as the remainder.

The above allocation method is only used as an example. When implementing one embodiment, other allocation methods such as a random allocation method (random(x) % N) may be configured according to actual conditions, which is not limited in one embodiment.

Sub-step S12: calculate, by the first working node, the feature frequency of the allocated first feature data.

Sub-step S13: transmit, by the first working node, to a second working node the calculated first feature data and the feature frequency.

In one embodiment, the first working node (such as a Map node) may calculate the allocated first feature data to obtain its feature frequency, and transparently transmit the feature frequency to the second working node (such as a Reduce node).

For example, a map function is defined to calculate the feature frequency of the first feature data.

Here, the data format of the calculation result may be (first feature data, feature frequency).

Sub-step S14: combine, by the second working node, the calculated first feature data and the feature frequency.

In the second working node (such as a Reduce node), the calculation results of the first working nodes (such as a Map node) can be combined to obtain a final result.

For example, a reduce function is defined to combine calculation results of Map nodes.

Here, the data format of the combination result may be (first feature data, feature frequency).

Step 102: obtain second feature data by filtering out low frequency feature data from the first feature data based on the feature frequency.

In one embodiment, the first feature data may be divided into low frequency feature data, mid-frequency feature data and high frequency feature data according to the feature frequency.

Here, the low frequency feature data may refer to feature data having the lowest feature frequency and occupying the first proportion of the total amount of the first feature data.

The mid-frequency feature data may refer to feature data having a relatively high feature frequency (higher than the feature frequency of the low frequency feature data and lower than that of the high frequency feature data) and occupying the second proportion of the total amount of the first feature data.

The high frequency feature data may refer to feature data having the highest feature frequency and occupying the third proportion of the total amount of the first feature data.

Since the low frequency feature data, the mid-frequency feature data, and the high frequency feature data are mutually different feature data, if the first feature data comprises the low frequency feature data, the mid-frequency feature data and the high frequency feature data, then the mid-frequency feature data can be the data other than the low frequency feature data and the high frequency feature data in the first feature data.

Certainly, the above division of feature data is only used as an example. When implementing one embodiment, other divisions of feature data may be set according to actual conditions. Examples include ultra-low frequency feature data, low frequency feature data, mid-frequency feature data, high frequency feature data, and ultra-high frequency feature data and the like, which is not limited in one embodiment. Moreover, in addition to the above divisions of feature data, those skilled in the art may also use other divisions of feature data according to actual needs, which is also not limited in one embodiment.

In the embodiments, the low frequency threshold may be pre-trained for filtering out the low frequency feature data.

Specifically, when the feature frequency of the first feature data is smaller than a preset low frequency threshold, it is determined that the first feature data is the low frequency feature data and then the first feature data may be filtered out to obtain the second feature data.

Since the low frequency feature data is filtered out, the second feature data comprises the mid-frequency feature data and the high frequency feature data.

Assuming that there are 5 pieces of first feature data and the feature frequencies thereof are:

(f1, 2), (f2, 4), (f3, 7), (f4, 8), (f5, 9)

If the low frequency feature data occupying 20%-25% of the total amount of the first feature data is filtered out from the first feature data, then the low frequency threshold may be set to 3, so that the first feature data f1 will be filtered out.

It should be noted that in different fields, the low frequency threshold is also different. The different first proportion for the low frequency data will also lead to the different low frequency threshold. Therefore, those skilled in the art could set the low frequency threshold according to actual situations, which is not limited in the disclosure.

In one embodiment, the low frequency threshold may be trained as follows.

Sub-step S21: train a first test model by employing first original feature data.

The so-called first original feature data is substantially also feature data and has a feature frequency. In one embodiment, the first original feature data may refer to source data from which low frequency feature data has not been filtered out, and may comprise low frequency feature data, mid-frequency feature data, and high-frequency feature data.

Machine learning may be carried out with the original feature data from which low frequency feature data has not been filtered out, so as to obtain the first test model through training.

Sub-step S22: train a second test model by employing the first original feature data having a feature frequency smaller than a first candidate threshold filtered out, the resulting feature data comprising candidate low threshold feature data.

In one embodiment, the first candidate threshold may be preset as an original low frequency threshold.

By filtering out a feature frequency smaller than the first candidate threshold from the first original feature data, it means that low frequency features are filtered out from the original feature data.

Machine learning is performed by employing the first original feature data from which the low frequency features have been filtered out, so as to obtain the second test model through training.

Sub-step S23: perform an A/B testing on the first test model and the second test model to obtain a first score and a second score.

Sub-step S24: determine that the first candidate threshold is the low frequency threshold when a difference between the first click-through rate and the second click-through rate is smaller than a preset first threshold difference.

The so-called A/B testing may involve formulating two solutions A and B (e.g., the first test model and the second test model) for the same target (e.g., the low frequency threshold) to allow some of users to use the solution A and other users to use the solution B. Usage conditions of the users (e.g., testing is performed on the first test model to obtain the first score, and testing is performed on the second test model to obtain the second score) is recorded and it is determined which solution is more suitable for the target.

Now using webpage information as an example. The first test model is used to extract first webpage information (e.g., advertisement data, news data, and the like) and the second test model is used to extract second webpage information (e.g., advertisement data, news data, and the like).

Regarding clients who access webpages, the first test model or the second test model is selected according to a probability of 50% to provide services, i.e., to display the first webpage information or the second webpage information.

The first click-through rate of the first webpage information is recorded as the first score and the second click-through rate of the second webpage information is recorded as the second score.

If the first score and the second score have weak equality (i.e., the difference between them is smaller than the preset first threshold difference), then the first candidate threshold may be considered suitable as the low frequency threshold; otherwise, a new first candidate threshold is selected to perform retraining.

In one embodiment, Step 102 may comprise the following sub-steps:

Sub-step S31: allocate the first feature data and the feature frequency to the one or the plurality of first working nodes.

In the distributed system, the first working node and a second working node are provided to perform filtering.

For example, in a distributed system such as Hadoop and ODPS, the first working node is a Map node and the second working node is a Reduce node.

In one embodiment, the first feature data and the feature frequency may be allocated to the one or a plurality of first working nodes by means of hash(x) % N, random(x) % N, and the like.

It should be noted that the first feature data may be represented in the form of a data ID.

Sub-step S32: obtain the second feature data, by the first working node, by filtering out the low frequency feature data from the allocated first feature data based on the allocated feature frequency.

Sub-step S33: transmit, by the first working node, to the second working node the second feature data obtained through filtering and the feature frequency.

In one embodiment, the first working node (such as a Map node) may filter out low frequency features from the allocated first feature data to obtain the second feature data and transparently transmit the second feature data to the second working node (such as a Reduce node).

For example, a map function is defined to determine that the first feature data is the low frequency feature data when the feature frequency of the first feature data is smaller than the preset low frequency threshold; and to filter out the first feature data.

Here, the data format of the filtering result may be (second feature data, feature frequency).

It should be noted that since the first feature data and the feature frequency thereof are paired, the low frequency feature data will be filtered out together with its feature frequency; and the second feature data will be retained together with its feature frequency.

Sub-step S34: combine, by the second working node, the second feature data obtained through filtering and the feature frequency.

In the second working node (such as a Reduce node), the filtering results of the first working nodes (such as a Map node) can be combined to obtain a final result.

For example, a reduce function is defined to combine filtering results of Map nodes.

Here, the data format of the combination result may be (second feature data, feature frequency).

Step 103: obtain the target feature data by filtering out at least part of mid-frequency feature data from the second feature data based on the feature frequency.

Since the mid-frequency feature data is useful for model training, in one embodiment, the mid-frequency feature data may be filtered out from the second feature data in a random manner.

Which part will be filtered out is done randomly, that is, the mid-frequency feature data is treated equally.

Other than the high frequency feature data that is included in the remaining target feature data after filtering, the remaining target feature data may or may not include the mid-frequency feature data.

With one embodiment, the mid-frequency threshold is pre-trained for filtering out the mid-frequency feature data.

Specifically, the second feature data may be configured with a random number (i.e., a randomly generated number) by means of Poisson distribution and the like.

When the product of the feature frequency of the second feature data and the random number is smaller than the preset mid-frequency threshold, it can be determined that the second feature data is the mid-frequency feature data; and the second feature data is filtered out to obtain the target feature data.

In an example of Poisson distribution, since Poisson distribution can generate a floating number between (0, 1) as the random number, it is possible to use 0.1 as a mid-frequency feature; and the second feature data that conforms to the following equation can be seen as the mid-frequency feature:

feature frequency*p <0.1,

where p is the random number generated by Poisson distribution.

It should be noted that in different fields, the mid-frequency threshold is also different. The different second proportion for the mid-frequency data will also lead to the different mid-frequency threshold. Therefore, those skilled in the art could set the mid-frequency threshold according to actual situations, which is not limited in the disclosure.

In one embodiment, the low frequency threshold may be trained as follows:

Sub-step S41: train a third test model by employing second original feature data.

The so-called second original feature data is substantially also feature data and has a feature frequency. In one embodiment, the second original feature data may refer to source data from which mid-frequency feature data has not been filtered out, and may comprise low frequency feature data, mid-frequency feature data, and high-frequency feature data.

Machine learning may be carried out with the second original feature data from which mid-frequency feature data has not been filtered out, so as to obtain the third test model through training.

Sub-step S42: train a fourth test model by employing the second original feature data having filtered out the product of the feature frequency and the random number that is smaller than a second candidate threshold.

In one embodiment, the second candidate threshold may be preset as an original mid-frequency threshold.

The feature frequency having the product of feature frequency and the random number smaller than the second candidate threshold is filtered out from the second original feature data, which is seen as filtering out mid-frequency features from the original feature data.

Machine learning is performed by employing the second original feature data from which the mid-frequency features have been filtered out, so as to obtain the fourth test model through training.

Sub-step S43: compute a first feature probability and a second feature probability.

Sub-step S44: determine that the second candidate threshold is the low frequency threshold when a difference between the first feature probability and the second feature probability is smaller than a preset second threshold difference.

In one embodiment, test data (including positive samples and negative samples) can be extracted to compute an Area Under Curve (AUC) value for the third test model and the fourth test model.

The AUC value is the area under the Receiver Operating Characteristic (Roc) curve, which is between 0.1 and 1 and can be used to intuitively evaluate the quality of the classifier. In general, a larger AUC value indicates a better performance of the classifier.

Specifically, the AUC value is a probability value. When a positive sample and a negative sample are randomly selected, the probability that the current classifier ranks the positive sample in front of the negative sample according to the computed Score value (the score value) is the AUC value.

In general, the larger the AUC value is, the more likely the current classification algorithm is to rank the positive sample in front of the negative sample, which gives a better classification performance.

In this way, in one embodiment, the first feature probability is a probability obtained when a score of a positive sample in the third test model is greater than a score of a negative sample in the third test model; and the second feature probability is a probability obtained when a score of the positive sample in the fourth test model is greater than a score of the negative sample in the fourth test model.

Therefore, when computing the AUC value, one property of AUC (which is equivalent to Wilcoxon-Mann-Whitney test) is used for this purpose.

The Wilcoxon-Mann-Whitney test is to test the probability when a score of an arbitrarily given positive class sample is greater than a score of an arbitrarily given negative class sample.

Method one: the number of pairs in which the score of the positive sample is greater than the score of the negative sample is calculated for all M×N (M is the number of positive samples and N is the number of negative samples) pairs of positive and negative samples.

When the scores of the positive and negative samples in a binary tuple (positive samples, negative samples) are equal, it is computed as 0.5 and then divided by MN:

$$AUC = \frac{{\sum }_{{ins}_{i} ∈ positiveclass} {rank}_{{ins}_{i}} - \frac{M \times ( M + 1 )}{2}}{M \times N}$$

Method two: the scores are ranked in a descending order; next, if the rank of the sample corresponding to the largest score is n, then the rank of the sample corresponding to the second largest score is n−1 and so on.

The ranks of all positive samples are added together and then the ranks of M positive samples with the smallest score are subtracted. What is obtained is the number of pairs in which the score of the positive sample is greater than the score of the negative sample in all samples, and then the number is divided by M×N:

AUC=((ranks of all positive samples added together)−M*(M+1))/(M*N)

If the first feature probability and the second feature probability have weak equality (i.e., the difference between them is smaller than the preset second threshold difference), then the second candidate threshold may be considered suitable as the mid-frequency threshold; otherwise, a new second candidate threshold is selected to perform retraining.

In one embodiment, Step 103 may comprise the following sub-steps.

Sub-step S51: allocate the second feature data and the feature frequency to the one or the plurality of first working nodes.

In the distributed system, the first working node and the second working node are provided to perform filtering.

For example, in a distributed system such as Hadoop and ODPS, the first working node is a Map node and the second working node is a Reduce node.

In one embodiment, the first feature data and the feature frequency may be allocated to the one or a plurality of first working nodes by means of hash(x) % N, random(x) % N, and the like.

It should be noted that the first feature data may be represented in the form of a data ID.

Sub-step S52: obtain the target feature data, by the second working node, by filtering out at least part of the mid-frequency feature data from the allocated second feature data based on the allocated feature frequency.

Sub-step S53: transmit, by the first working node, to the second working node the target feature data obtained through filtering and the feature frequency.

In one embodiment, the first working node (such as a Map node) may filter out mid-frequency features from the allocated second feature data to obtain the target feature data, and transparently transmit the target feature data to the second working node (such as a Reduce node).

For example, a map function is defined to determine that the second feature data is the mid-frequency feature data when the product of the feature frequency of the second feature data and the random number is smaller than the preset mid-frequency threshold; and to filter out the second feature data.

Here, the data format of the filtering result may be (target feature data, feature frequency).

It should be noted that since the second feature data and the feature frequency thereof are paired, the mid-frequency feature data will be filtered out together with its feature frequency; and the target feature data will be retained together with its feature frequency.

Sub-step S54: combine, by the second working node, the target feature data obtained through filtering and the feature frequency.

In the second working node (such as a Reduce node), the filtering results of the first working nodes (such as a Map node) can be combined to obtain a final result.

For example, a reduce function is defined to combine filtering results of Map nodes.

Here, the data format of the combination result may be (target feature data, feature frequency).

The target feature data from which the low frequency feature data and at least part of mid-frequency feature data have been filtered out can be used to train a specified model, for example, a Support Vector Machine (SVM), a logistic regression model, a deep learning (DP) model, and the like, which is not limited in one embodiment.

In many cases, the amount of the low frequency feature data and the mid-frequency feature data accounts for about 80%-90% of the total amount of the feature data; and the high frequency feature data accounts for about 10%-20% of the total amount of the feature data.

Therefore, ideally, the model can be trained with only 10%-20% of the retained high frequency feature data.

However, a lot of mid-frequency feature data can better capture the needs of long-tail users and often these mid-frequency feature data cannot be discarded directly.

As the low frequency feature data occurs with very low frequency, it basically has no effect on the performance of the model after it is filtered out in the situation where the total amount of feature data is very large.

For example, when a user is deciding whether to buy a book, various feature data that the user may consider include: low frequency feature data: weather; mid-frequency feature data: book cover; and high frequency feature data: content quality of the book.

In fact, when buying a book, most users do not take into account the weather and pay less attention to the book cover. Instead, it is the content quality of the book on which the users would focus.

Therefore, filtering out the low frequency feature data of weather or the mid-frequency feature data of book cover and retaining high frequency feature data of book quality or the mid-frequency feature data book cover has no impact on the training performance of a book buying model.

In view of the above, features of the entire group are obtained. Taking the major features of the group (such as the content quality of the book) into consideration and filtering out the minor features (such as the weather) basically have no impact on the performance of the model.

Currently, globally filtering out features through a frequency threshold without making a distinction among low frequency feature data, mid-frequency feature data, and high frequency feature data may possibly filter out a large amount of useful feature data (such as mid-frequency features or even high frequency features), which leads to a significantly reduced machine learning effect.

Through filtering out low frequency feature data and at least part of mid-frequency feature data in the embodiments of the disclosure, the obtained target feature data has high frequency feature data and may possibly have part of mid-frequency feature data. Training a model based on such target feature data does not affect the performance of a model essentially, and greatly reduces the number of features while ensuring the effect of machine learning. The solutions provided in the embodiments of the disclosure therefore greatly reduce the needed number of machines and resources, which in turn greatly shortens the training time and increases the training speed, thereby lowering the training costs to the greatest extent.

It should be noted that with regard to the method embodiments, all of them are expressed as a combination of a series of actions for simplicity of description. Those skilled in the art will recognize that the embodiments are not limited by the described order of actions as some steps may, in accordance with the embodiments, be carried out in other orders or simultaneously. Secondly, those skilled in the art should also appreciate that the embodiments described in the specification all belong to exemplary embodiments and that the involved actions are not necessarily required by the embodiments.

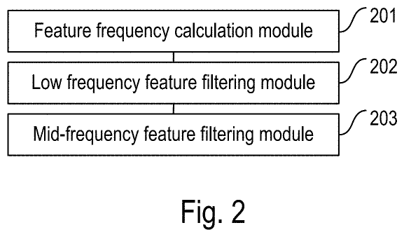

FIG. 2 is a block diagram illustrating an apparatus for mining target feature data according some embodiments of the disclosure. The apparatus may comprise the following modules: a feature frequency calculation module 201, configured for calculating a feature frequency of first feature data; a low frequency feature filtering module 202, configured for obtaining second feature data by filtering out low frequency feature data from the first feature data based on the feature frequency; and a mid-frequency feature filtering module 203, configured for obtaining the target feature data by filtering out at least part of mid-frequency feature data from the second feature data based on the feature frequency.

In one embodiment, the apparatus may further comprise the following modules: a model training module, configured for training a specified model by employing the target feature data.

In one embodiment, the feature frequency calculation module 201 may comprise the following sub-modules: a first allocation sub-module, configured for allocating the first feature data to one or a plurality of first working nodes; a frequency calculation sub-module, configured to be used by the first working node to calculate the feature frequency of the allocated first feature data; a first transmission sub-module, configured to be used by the first working node to transmit to a second working node the calculated first feature data and the feature frequency; and a first combination sub-module, configured to be used by the second working node to combine the calculated first feature data and the feature frequency.

In one embodiment, the low frequency feature filtering module 202 may comprise the following sub-modules: a low frequency feature determination sub-module, configured for determining that the first feature data is low frequency feature data when the feature frequency of the first feature data is lower than a preset low frequency threshold; and a second feature data obtaining sub-module, configured for obtaining the second feature data by filtering out the first feature data.

In another embodiment of the disclosure, the low frequency feature filtering module 202 may comprise the following sub-modules: a second allocation sub-module, configured for allocating the first feature data and the feature frequency to the one or the plurality of first working nodes; a first filtering sub-module, configured to be used by the first working node to obtain the second feature data by filtering out the low frequency feature data from the allocated first feature data based on the allocated feature frequency; a second transmission sub-module, configured to be used by the first working node to transmit to the second working node the second feature data obtained through filtering and the feature frequency; and a second combination sub-module, configured to be used by the second working node to combine the second feature data obtained through filtering and the feature frequency.

In one embodiment, the mid-frequency feature filtering module 203 may comprise the following sub-modules: a random number configuration sub-module, for configuring a random number for the second feature data; a mid-frequency feature determination sub-module, configured for determining that the second feature data is the mid-frequency feature data when the product of the feature frequency of the second feature data and the random number is smaller than a preset mid-frequency threshold; and a target feature data obtaining sub-module, configured for obtaining the target feature data by filtering out the second feature data.

In another embodiment of the disclosure, the mid-frequency feature filtering module 203 may comprise the following sub-modules: a third allocation sub-module, configured for allocating the second feature data and the feature frequency to the one or the plurality of first working nodes; a second filtering sub-module, configured to be used by the second working node to obtain the target feature data by filtering out at least part of the mid-frequency feature data from the allocated second feature data based on the allocated feature frequency; a third transmission sub-module, configured to be used by the first working node to transmit to the second working node the target feature data obtained through filtering and the feature frequency; and a third combination sub-module, configured to be used by the second working node to combine the target feature data obtained through filtering and the feature frequency.

In one embodiment, the apparatus may further comprise the following modules: a first test model training module, configured for training a first test model by employing first original feature data; a second test model training module, configured for training a second test model by employing the first original feature data having a feature frequency smaller than a first candidate threshold filtered out; a test module, configured for performing an A/B testing on the first test model and the second test model to obtain a first score and a second score; and a low frequency threshold determination module, configured for determining that the first candidate threshold is the low frequency threshold when a difference between the first click-through rate and the second click-through rate is smaller than a preset first threshold difference.

In one embodiment, the apparatus may further comprise the following modules: a third test model training module, configured for training a third test model by employing second original feature data; a fourth test model training module, configured for training a fourth test model by employing the second original feature data having filtered out the product of the feature frequency and the random number that is smaller than a second candidate threshold; a probability computation sub-module, configured for computing a first feature probability and a second feature probability; and a mid-frequency threshold determination module, configured for determining that the second candidate threshold is the low frequency threshold when a difference between the first feature probability and the second feature probability is smaller than a preset second threshold difference, wherein the first feature probability is a probability obtained when a score of a positive sample in the third test model is greater than a score of a negative sample in the third test model; and the second feature probability is a probability obtained when a score of the positive sample in the fourth test model is greater than a score of the negative sample in the fourth test model.

With regard to the apparatus embodiments, because the apparatus embodiments are substantially similar to the method embodiments, the description is relatively concise, and reference can be made to the description of the method embodiments for related parts.

Various embodiments in the specification are described in a progressive way, each embodiment focuses on the differences one has from others; and for the same or similar parts between various embodiments, reference may be made to the description of other embodiments.

Those skilled in the art should note that embodiments of the disclosure may be provided as a method, an apparatus, or a computer program product. Therefore, an embodiment of the disclosure may use forms of a full hardware embodiment, a full software embodiment, or an embodiment combining software and hardware aspects. Moreover, an embodiment of the disclosure may employ the format of a computer program product implemented on one or more computer usable storage media (including, but not limited to, a magnetic disk memory, a CD-ROM, an optical memory, and so on) containing computer usable program code therein.

In a typical configuration, the computer device includes one or more processors (CPUs), input/output interfaces, network interfaces, and memories. The memory may include computer-readable medium in the form of non-permanent memory, random access memory (RAM) and/or non-volatile memory or the like, such as read-only memory (ROM) or flash memory (flash RAM). The memory is an example of a computer-readable medium. The computer-readable medium includes permanent and non-permanent, movable and non-movable media that can achieve information storage by means of any methods or techniques. The information may be computer-readable instructions, data structures, modules of programs or other data. Examples of the computer storage medium include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disk (DVD) or other optical storages, magnetic cassette, magnetic tape, magnetic disk storage or other magnetic storage devices, or any other non-transmission medium that can be used for storing information accessible by a computing device. In light of the definitions herein, the computer readable medium does not include transitory computer readable media (transitory media), such as modulated data signals and carrier waves.

The embodiments of the disclosure are described with reference to flow charts and/or block diagrams according to the method, terminal device (system) and computer program product according to the embodiments of the disclosure. It should be understood that each flow and/or block in the flowcharts and/or block diagrams, and a combination of flows and/or blocks in the flowcharts and/or block diagrams can be implemented with computer program instructions. These computer program instructions may be provided to a general-purpose computer, a special-purpose computer, an embedded processor, or a processor of any other programmable data processing terminal device to generate a machine, so that the instructions executed by a computer or a processor of any other programmable data processing terminal device generate an apparatus for implementing a specified function in one or more processes in the flowcharts and/or in one or more blocks in the block diagrams.

These computer program instructions may also be stored in a computer-readable memory that can direct a computer or another programmable data processing terminal device to operate in a particular manner, such that the instructions stored in the computer-readable memory produce an article of manufacture including instruction means, the instruction means implementing the functions specified in one or more flows of the flowcharts and/or one or more blocks of the block diagrams.

These computer program instructions may also be loaded onto a computer or another programmable data processing terminal device such that a series of operational steps are performed on the computer or another programmable terminal device to produce a computer-implemented processing, and thus the instructions executed on the computer or another programmable terminal device provide the steps for implementing the functions specified in one or more flows of the flowcharts and/or one or more blocks of the block diagrams.

Preferred embodiments of the embodiments of the disclosure have been described; however, once knowing basic creative concepts, those skilled in the art can make other variations and modifications on these embodiments. Therefore, the appended claims are intended to be interpreted as including the preferred embodiments and all variations and modifications falling within the scope of the embodiments of the disclosure.

Finally, it should be further noted that, in this text, the relation terms such as first and second are merely used to distinguish one entity or operation from another entity or operation, and do not require or imply that the entities or operations have this actual relation or order. Moreover, the terms “include”, “comprise” or other variations thereof are intended to cover non-exclusive inclusion, so that a process, a method, an article or a terminal device including a series of elements not only includes the elements, but also includes other elements not clearly listed, or further includes inherent elements of the process, method, article or terminal device. In a case without any more limitations, an element defined by “including a/an . . . ” does not exclude that the process, method, article or terminal device including the element further has other identical elements.

A method of mining target feature data and the apparatus of mining target feature data provided in the disclosure are introduced above in detail. The principles and implementations of the disclosure are set forth herein with reference to specific examples. Descriptions of the above embodiments are merely served to assist in understanding the method and the essential ideas of the disclosure. Those of ordinary skill in the art may make changes to specific implementations and application scopes according to the ideas of the disclosure. In view of the above, the content of the description should not be construed as limiting the disclosure.

1-18. (canceled)

19. A method comprising:
calculating, by a distributed system, a feature frequency of first feature data;
obtaining, by the distributed system, second feature data by filtering out low frequency feature data from the first feature data based on the feature frequency; and
obtaining, by the distributed system, target feature data by filtering out at least part of the mid-frequency feature data from the second feature data based on the feature frequency

20. The method of claim 19, further comprising generating first feature data by filtering a plurality of web log entries, each web log entry comprising a plurality of fields, the first feature data comprising a subset of the plurality of fields in the web log entries.

21. The method of claim 19, the calculating the feature frequency of first feature data comprising:
allocating, by the distributed system, the first feature data to first working nodes;
calculating, by the distributed system, the feature frequency of the first feature data at the first working nodes;
transmitting, by the distributed system, the feature frequency and the first feature data from the first working nodes to second working nodes; and
combining, by the distributed system, the feature frequency and the first feature data.

22. The method of claim 21, the first working nodes comprising Map nodes and the second working nodes comprising Reduce nodes.

23. The method of claim 19, further comprising dividing the first feature data into one or more tiers of feature data based on the feature frequency distribution.

24. The method of claim 19, the obtaining second feature data by filtering out low frequency feature data comprising filtering the first feature data based on a low frequency threshold, the low frequency threshold being set by training a test model.

25. The method of claim 24, the training the test model comprising:
using, by the distributed system, the first feature data as training data;
generating, by the distributed system, the test model using the training data and a machine learning model;
training, by the distributed system, a second test model using candidate low frequency feature data, the candidate low frequency feature data selected using a candidate frequency threshold;
performing, by the distributed system, A/B testing on the test model and the second test model to obtain a first score and a second score; and
using, by the distributed system, the candidate frequency threshold as the low frequency threshold if a difference between the first score and the second score is smaller than a preset threshold difference.

26. The method of claim 24, the training the test model comprising:
using, by the distributed system, the first feature data as training data;
generating, by the distributed system, the test model using the training data and a machine learning model;
training, by the distributed system, a fourth test model using the first feature data after filtering out a product of the feature frequency and a random number that is smaller than a second candidate threshold;
computing, by the distributed system, a first feature probability and a second feature probability; and
determining, by the distributed system, that the second candidate threshold is the low frequency threshold when a difference between the first feature probability and the second feature probability is smaller than a preset second threshold difference.

27. The method of claim 19, the obtaining second feature data by filtering out low frequency feature data comprising:
allocating, by the distributed system, the first feature data and the feature frequency to first working nodes obtaining, by the distributed system, the second feature data by filtering out the low frequency feature data from the allocated first feature data based on the allocated feature frequency;
transmitting, by the distributed system, the second feature data and the feature frequency to a second working node; and
combining, by the distributed system, the second feature data and the feature frequency.

28. The method of claim 19, the obtaining target feature data further comprising:
allocating, by the distributed system, the second feature data and the feature frequency to first working nodes;
obtaining, by the distributed system, the target feature data by filtering out at least part of the mid-frequency feature data from the allocated second feature data based on the feature frequency;
transmitting, by the distributed system, the target feature data obtained through filtering and the feature frequency to a second working node; and
combining, by the distributed system, the target feature data obtained through filtering and the feature frequency.

29. A system comprising:
a processor; and
a storage medium for tangibly storing thereon program logic for execution by the processor, the stored program logic comprising:
logic, executed by the processor, for calculating a feature frequency of first feature data;
logic, executed by the processor, for obtaining second feature data by filtering out low frequency feature data from the first feature data based on the feature frequency; and
logic, executed by the processor, for obtaining target feature data by filtering out at least part of the mid-frequency feature data from the second feature data based on the feature frequency

30. The apparatus of claim 29, further comprising logic, executed by the processor, for generating first feature data by filtering a plurality of web log entries, each web log entry comprising a plurality of fields, the first feature data comprising a subset of the plurality of fields in the web log entries.

31. The apparatus of claim 29, the logic for calculating the feature frequency of first feature data comprising:
logic, executed by the processor, for allocating the first feature data to first working nodes;
logic, executed by the processor, for calculating the feature frequency of the first feature data at the first working nodes;
logic, executed by the processor, for transmitting the feature frequency and the first feature data from the first working nodes to second working nodes;
logic, executed by the processor, for combining the feature frequency and the first feature data.

32. The apparatus of claim 31, the first working nodes comprising Map nodes and the second working nodes comprising Reduce nodes.

33. The apparatus of claim 29, further comprising dividing the first feature data into one or more tiers of feature data based on the feature frequency distribution.

34. The apparatus of claim 29, the logic for obtaining second feature data by filtering out low frequency feature data comprising logic, executed by the processor, for filtering the first feature data based on a low frequency threshold, the low frequency threshold being set by training a test model.

35. The apparatus of claim 34, the logic for training the test model comprising:
logic, executed by the processor, for using the first feature data as training data;
logic, executed by the processor, for generating the test model using the training data and a machine learning model;
logic, executed by the processor, for training a second test model using candidate low frequency feature data, the candidate low frequency feature data selected using a candidate frequency threshold;
logic, executed by the processor, for performing A/B testing on the test model and the second test model to obtain a first score and a second score; and
logic, executed by the processor, for using the candidate frequency threshold as the low frequency threshold if a difference between the first score and the second score is smaller than a preset threshold difference.

36. The apparatus of claim 34, the logic for training the test model comprising:
logic, executed by the processor, for using the first feature data as training data;
logic, executed by the processor, for generating the test model using the training data and a machine learning model;
logic, executed by the processor, for training a fourth test model using the first feature data after filtering out a product of the feature frequency and a random number that is smaller than a second candidate threshold;
logic, executed by the processor, for computing a first feature probability and a second feature probability; and
logic, executed by the processor, for determining that the second candidate threshold is the low frequency threshold when a difference between the first feature probability and the second feature probability is smaller than a preset second threshold difference.

37. The apparatus of claim 29, the logic for obtaining second feature data by filtering out low frequency feature data comprising:
logic, executed by the processor, for allocating the first feature data and the feature frequency to first working nodes
logic, executed by the processor, for obtaining the second feature data by filtering out the low frequency feature data from the allocated first feature data based on the allocated feature frequency;
logic, executed by the processor, for transmitting the second feature data and the feature frequency to a second working node; and
logic, executed by the processor, for combining the second feature data and the feature frequency.

38. The apparatus of claim 29, the logic for obtaining target feature data further comprising:
logic, executed by the processor, for allocating the second feature data and the feature frequency to first working nodes;
logic, executed by the processor, for obtaining the target feature data by filtering out at least part of the mid-frequency feature data from the allocated second feature data based on the feature frequency;
logic, executed by the processor, for transmitting the target feature data obtained through filtering and the feature frequency to a second working node; and
logic, executed by the processor, for combining the target feature data obtained through filtering and the feature frequency.
